(19) United States
(12) Patent Application Publication
(10) Pub. No.: US 2018/0092107 A1
(43) Pub. Date: Mar. 29, 2018

(54) ON THE FLY SCHEDULING AND POWER SAVING

(71) Applicants: Laurent Cariou, Portland, OR (US); Chittabrata Ghosh, Fremont, CA (US)

(72) Inventors: Laurent Cariou, Portland, OR (US); Chittabrata Ghosh, Fremont, CA (US)

(21) Appl. No.: 15/279,284

(22) Filed: Sep. 28, 2016

(51) Int. Cl. H04W 72/12; H04W 52/02

(52) U.S. Cl. CPC H04W 72/1205; H04L 27/26; H04W 52/0225

(57) ABSTRACT

Methods and devices are described in which an access point of a wireless network sends rendezvous time information to one or multiple associated stations. The rendezvous time information indicates a point in time at which the access point will try to access the wireless channel and schedule traffic for the stations. Based on that information, the stations will be able to decide if it is worth going into sleep mode until that rendezvous time or if it should stay awake.

### TECHNICAL FIELD

Embodiments described herein relate generally to wireless networks and communications systems.

### BACKGROUND

Wireless networks as defined by the IEEE 802.11 specifications (sometimes referred to as Wi-Fi) are currently being advanced to provide much greater average throughput per user to serve future communications needs. The IEEE 802.11ax standard as presently proposed incorporates features that include, for example, downlink and uplink multi-user (MU) operation by means of orthogonal frequency division multiple access (OFDMA) and multi-user multiple-input-multiple-output (MU-MIMO) technologies. These features require an access point of a wireless network to take a more active role in scheduling downlink and uplink transmissions of associated stations. The present disclosure is concerned with the use of information relating to such scheduling to enable power saving by the stations.

### BRIEF DESCRIPTION OF THE DRAWINGS

FIG. 1 illustrates a basic service set that includes station devices associated with an access point according to some embodiments.

FIG. 2 illustrates use of a separate rendezvous frame for transmitting rendezvous time information according to some embodiments.

FIG. 3 illustrates transmission multicast rendezvous frame together with unicast rendezvous frames according to some embodiments.

FIG. 4 illustrates an example of a rendezvous frame according to some embodiments.

FIG. 5 illustrates the per user information field of a rendezvous frame according to some embodiments.

FIG. 6 illustrates an example of a multi-STA control information subfield according to some embodiments.

FIG. 7 illustrates transmission of rendezvous time information in a multi-user block acknowledgement with per station feedback according to some embodiments.

FIG. 8 illustrates transmission of rendezvous time information in a multi-user block acknowledgement with multi-station feedback according to some embodiments.

FIG. 9 illustrates an example of a multi-station rendezvous field according to some embodiments.

FIG. 10 illustrates an example of a multi-station rendezvous field according to some embodiments.

FIG. 11 illustrates transmission of rendezvous time information in a multi-user block acknowledgement in response to short feedback transmissions according to some embodiments.

FIG. 12 illustrates an example of a user equipment device according to some embodiments.

FIG. 13 illustrates an example of a computing machine according to some embodiments.

### DETAILED DESCRIPTION

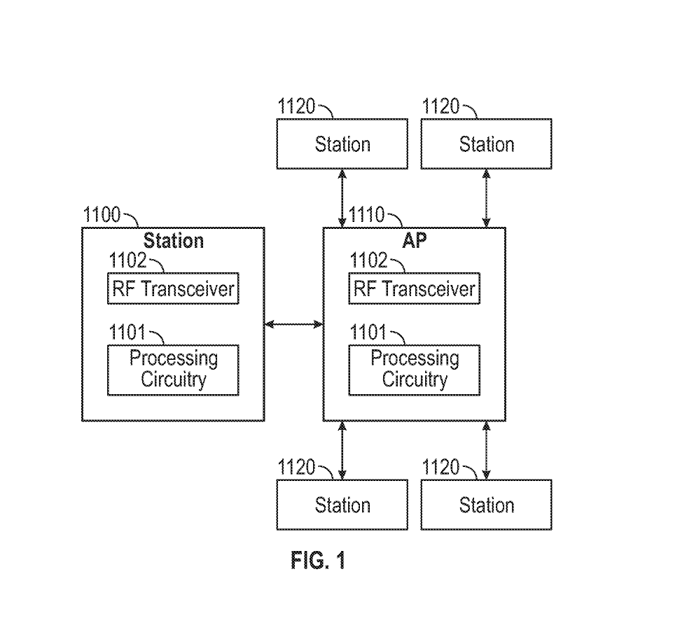

In an 802.11 local area network (LAN), the entities that wirelessly communicate are referred to as stations (STAs). A basic service set (BSS) refers to a plurality of stations that remain within a certain coverage area and form some sort of association and is identified by the SSID of the BSS. In one form of association, the stations communicate directly with one another in an ad-hoc network. More typically, however, the stations associate with a central station dedicated to managing the BSS and referred to as an access point (AP). FIG. 1 illustrates a BSS that includes a station device 1100 associated with an access point (AP) 1110, where the AP 1110 may be associated with a number of other stations 1120. The device 1100 may be any type of device with functionality for connecting to a WiFi network such as a computer, smart phone, or a UE (user equipment) with WLAN access capability, the latter referring to terminals in a LTE (Long Term Evolution) network. Each of the station devices include an RF (radio frequency transceiver) 1102 and processing circuitry 1101 as shown by the depictions of devices 1100 and 1110. The processing circuitry includes the functionalities for WiFi network access via the RF transceiver as well as functionalities for processing as described herein. The RF transceivers of the station device 1100 and access point 1110 may each incorporate one or more antennas. The RF transceiver 1100 with multiple antennas and processing circuitry 101 may implement one or more MIMO (multi-input multi-output) techniques such as spatial multiplexing, transmit/receive diversity, and beam forming. The devices 1100 and 1110 are representative of the wireless access points and stations described below.

In an 802.11 WLAN network, the stations communicate via a layered protocol that includes a physical layer (PHY) and a medium access control (MAC) layer. The MAC layer is a set of rules that determine how to access the medium in order to send and receive data, and the details of transmission and reception are left to the PHY layer. At the MAC layer, transmissions in an 802.11 network are in the form of MAC frames of which there are three main types: data frames, control frames, and management frames. Data frames carry data from station to station. Control frames, such as request-to-send (RTS) and clear-to-send (CTS) frames are used in conjunction with data frames deliver data reliably from station to station. Management frames are used to perform network management functions. Management frames include beacon frames which are transmitted periodically by the AP at defined beacon intervals and which contain information about the network and also indicate whether the AP has buffered data which is addressed to a particular station or stations.

The 802.11ax standard provides for downlink (DL) and uplink (UL) multi-user (MU) operation. Multiple simultaneous transmissions to different STAs from the AP in the DL and from multiple STAs to the AP in the UL are enabled via MU-MIMO and/or orthogonal frequency division multiple access (OFDMA). With OFDMA, the AP assigns separate subsets of OFDMA subcarriers, referred to as resource units (RUs), to individual STAs for UL and DL transmissions. With MU-MIMO, multiple antenna beamforming techniques are used to form spatial streams (SSs) that the AP assigns to STAs for UL and DL transmissions.

In order to implement UL and DL MU operations as defined by the 802.11ax standard, the AP is more involved than in previous generations of the standard in scheduling UL and DL data transfers. A STA in an 802.11ax network can also rely more on AP scheduling for its channel access. Such scheduling by the AP affects how STAs operating in a power saving (PS) mode (i.e., where the STA is in either an awake or a sleep state) operate. For example, a STA may need to send something over the UL, or may know that it needs to receive data from the AP over DL, and cannot go into sleep mode until after such transmissions are scheduled by the AP. In that situation, however, the AP knows approximately when such transmissions will be scheduled. It may know, for instance, that the future DL PPDU (physical protocol data unit) transmissions will be used for other STAs in priority and that this particular STA will be scheduled only afterwards. If such on-the-fly scheduling information were to be shared by the AP with STAs, the AP would enable the STAs to save power. For example, the AP could indicate a rendezvous time when it expects to schedule DL/UL traffic for a STA (or when it expects to access the channel if the AP is not the TxOP holder at that instant). The STA would then be able to go into sleep mode until the rendezvous time at which point the traffic would be scheduled.

Described herein are methods and apparatus in which an AP sends rendezvous time (RVT) information to one or multiple STAs indicating a point in time at which the AP will try to access the channel and schedule UL and/or DL traffic for the STA(s). Based on that information, the STAs will be able to decide if it is worth going into sleep mode until that rendezvous time or if it should stay awake. In various embodiments, the RVT information may be included in block acknowledgements (BAs) or multi-STA block acknowledgements (M-BAs), included in a target wake time (TWT) broadcast element, included in a separate unicast or broadcast frame referred to as a rendezvous frame (RDV frame) that would be sent in a DL MU PPDU, or piggybacked in a DL data frame or control frame as a subfield of the HE variant of the HT control field. The RVT information may indicate the RVT as a duration between the time the RVT information is transmitted and when the RVT will occur. The RVT information may further include the AID of the STA if needed and possible characteristics of what will be scheduled at the RVT such as UL traffic only, DL traffic only, UL and DL traffic, or unknown. These and other embodiments are described in more detail below. Also described are techniques to compress the RVT information and reduce its overhead that are particularly applicable to cases where the RVT information is to be multi-casted to multiple STAs.

### RDV Frame

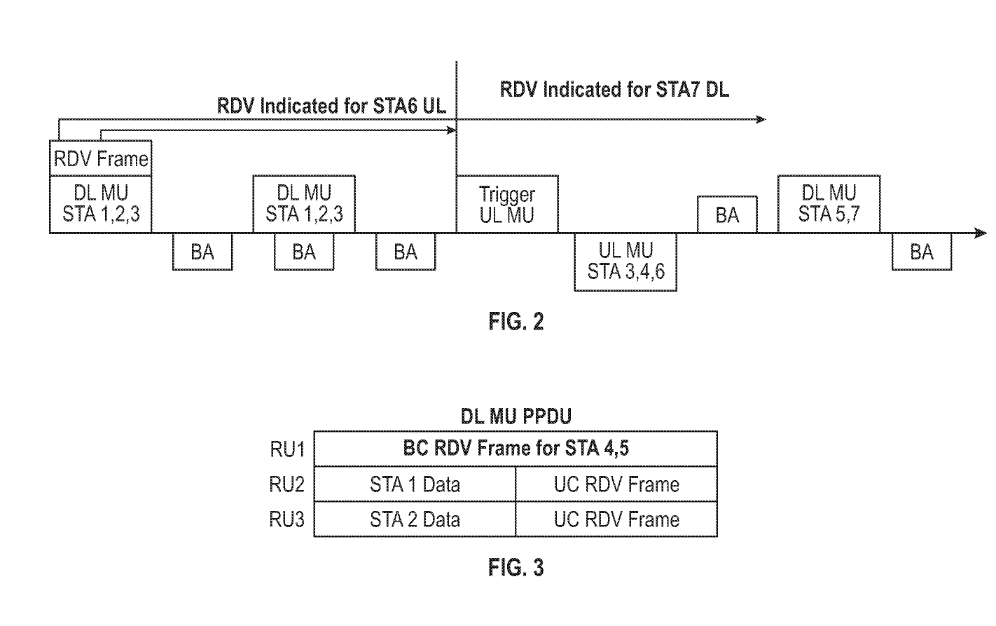

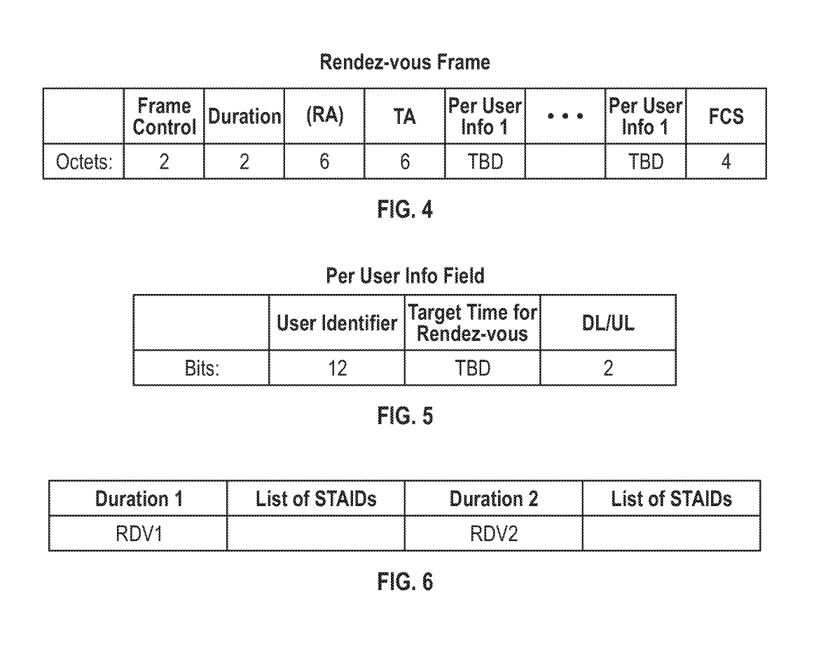

In one embodiment, the AP sends RVT information in a separate RDV frame. The RDV frame can be sent in a particular RU as a broadcast frame (BC RDV frame for multiple STAs) or as a unicast frame (UC RDV frame for a single STA). FIG. 2 illustrates transmission of an RDV frame along with a DL MU transmission for STAs 1, 2, and 3. The RDV frame contains an RVT for STA 6 to be triggered for an UL transmission and an RVT for STA 7 to receive a DL transmission, where the RVTs may take place in a subsequent TxOP. In some embodiments, an RDV frame does not include any information about a STA that is scheduled at the same time as the RDV frame in a different RU as illustrated by FIG. 3 where the BC RDV frame includes RVT information for STAs 4 and 5 but not for STAs 1 and 2 that are scheduled at the same time. FIG. 4 illustrates an example of an RDV frame that includes a frame control field, a duration field, a receive address (RA) field, a transmit address (TA) field, a frame check sequence (FCS) field, and multiple per-user information fields. Note that if multicasted, the RA address is a multicast or broadcast address. If unicasted, the RA address is the address of the destination STA. An example of a per-user information field as shown in FIG. 5 includes a user identifier field, a field to indicate the RVT, and a field to indicate whether an UL or DL transmission is to be scheduled at the RVT.

### Subfield of HE Variant of HT-Control Field

In another embodiment, the RVT information is sent along with a data frame in the HE (high-efficiency) variant of the HT (high-throughput) control field. A separate category for the RVT/TWT information is defined and indicated by the control ID subfield. The RVT/TWT information is then contained in the control information subfield of the HT control field if so indicated by the control ID subfield. The control information subfield in that case may contain, for example, a duration until the RVT and whether an UL or DL transmission is to be scheduled at the RVT. In some embodiments, the control information subfield of the HE variant of HT control field contains RVT information for only one STA in a unicast frame. In other embodiments, the HE-variant of the HT control field contains RVT information for multiple STAs and is transmitted as a common feedback in a multicast frame. For example, the HE-variant of the HT control field containing RVT information may be sent as part of common feedback along with the M-BA that the AP is sending. FIG. 6 illustrates an example of a multi-STA control information subfield that includes a duration until a first rendezvous RDV1, a list of STA IDs for RDV1, a duration until a second rendezvous RDV2, and a list of STA IDs for RDV2. Unicast and multicast frames may be in the same category or different categories as identified by the control ID subfield. If different categories, there would be a category for unicast RVT information and a category for multicast RVT information, and the multi-STA RVT category may include the AID of the STAs and their related RVT information. In some embodiments, the content of the RVT/TWT information may be designed with the existing TWT element or with a modified TWT element.

### RVT Information in M-BA

In other embodiments, the RVT information is included in an M-BA transmitted in response to UL transmissions from STAs on specific resources assigned to the STAs in a trigger frame sent by the AP. Examples of such UL transmissions include UL MU data frames, OFDMA random access frames, bandwidth request frames, and ps-poll frames. The specific resources assigned to the STAs may be RUs, SSs, or a combination of thereof. In the latter case each STA is assigned a specific orthogonal allocation referred to as a resource block (RB) on the HE-LTF (high efficiency long training field) dimensions (specific 26-tone RUs in the frequency domain and a specific P-matrix spreading code in the time domain). That is, each STA is uniquely assigned an RB defined by a particular spatial stream (SS) that corresponds to a row of the P-matrix and by a particular RU. A STA may thus identify itself to the AP by transmitting a signal using the assigned RB. In what is referred to herein as short feedback, the AP sends a type of trigger frame that asks a specific question of the STAs that receive the frame. Such questions could relate, for example, to whether the STA is awake in case the AP has buffered DL data to send or to whether the STA has UL to send. In response to the trigger frame, STAs may then respond by sending an UL MU-NDP with energy in the HE-LTF to the AP on their assigned RB. The transmission of this signal is understood by the AP as being a positive answer (i.e., if energy is detected) to the question and the ID of the STA is known by the RB in which energy is detected. The AP can then send an M-BA to acknowledge to the STA that it received the answer and include the RVT information as well.

Examples of the use of short feedback include the following. In a first example, after transmission of a beacon, the AP sends a trigger to request transmission of PS-poll frames from multiple STAs using short UL MU-NDP feedback as described above. The AP thus receives information about all the STAs that are awake and for which it has buffered data to send. The AP can possibly schedule some STAs right away but may have to schedule other STAs in a following TxOP at the RVT, for instance. The AP then provides RVT information in the M-BA that immediately follows the PS-poll frames to those STAs that will be scheduled later. In a second example, the AP sends a trigger to request a short resource request from STAs using the UL MU-NDP feedback as described above. The AP thus receives information about all the STAs that need to schedule an UL transmission. The AP may possibly schedule some STAs right away but may have to schedule other STAs in a following TxOP at the RVT, for instance. The AP then provides the RVT information in the M-BA that immediately follows the resource requests to those STAs that will be scheduled later.

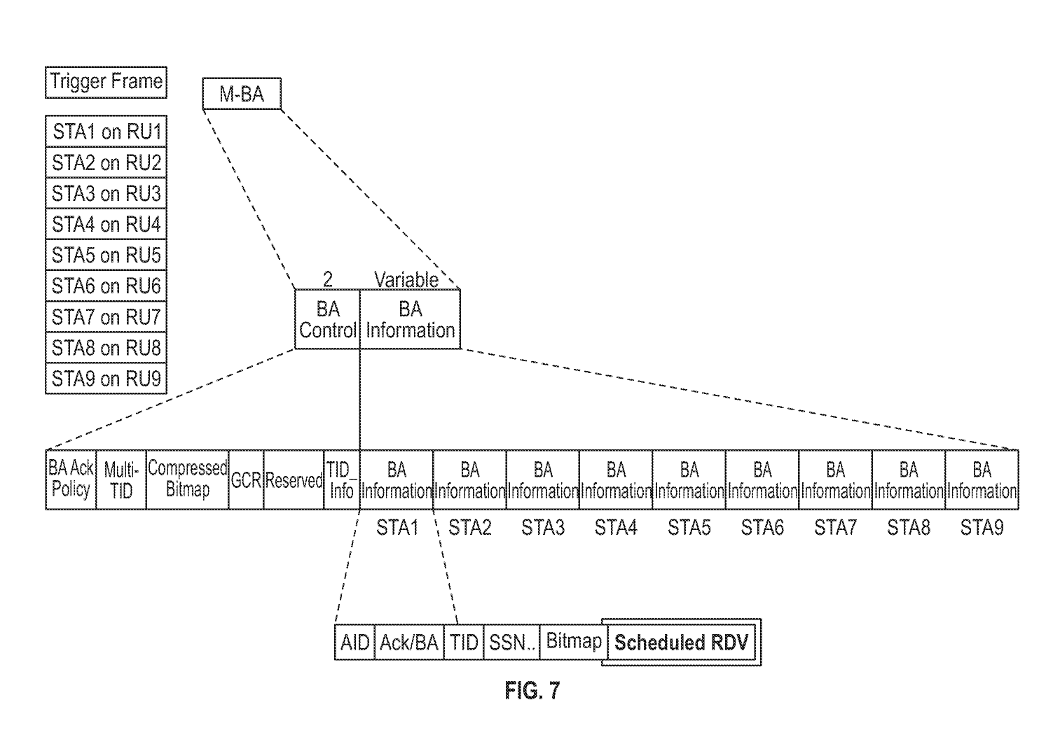

In one embodiment, the RVT information may be included in an M-BA with a per-STA feedback as the AP already has per-STA BA information to acknowledge the UL transmission. This would be a unicast type of feedback as in the fields as in the unicast designs for the HE variant of HT control field discussed above. FIG. 7 illustrates an example of such per-STA feedback where a trigger frame elicits transmissions by STA1 through STA9 on RU1 through RU9, respectively. The M-BA frame sent by the AP in response then includes a BA information field for each of STA1 through STA9. The BA information field for each STA includes the AID of the STA and the RVT information for that STA.

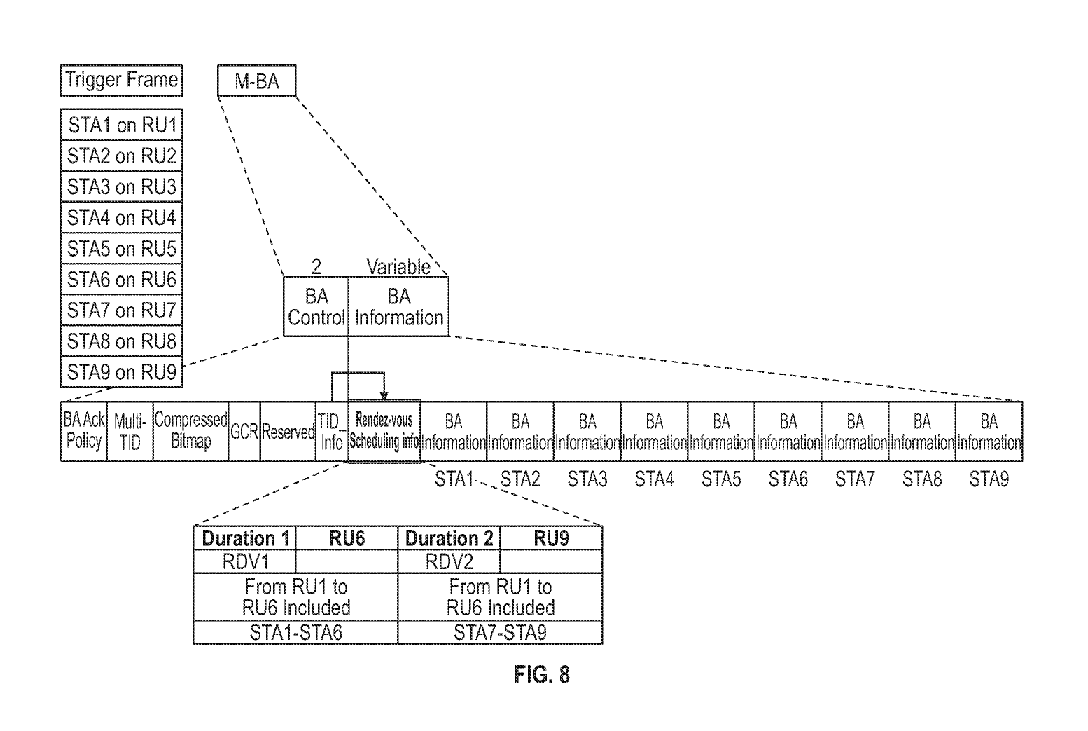

Alternatively, the RVT information may be included in an M-BA in a multi-STA RDV feedback field as illustrated in FIG. 8 where it is denoted as the rendezvous scheduling information field. A trigger frame elicits transmissions by STA1 through STA9 on RU1 through RU9, respectively. The M-BA frame sent by the AP in response then includes a multi-STA RDV field that includes the RVT information for STA1 through STA9. In one embodiment, as shown in FIG. 8, the multi-STA RDV field may include a duration until a first rendezvous RDV1, an RU identifier serving as a boundary to indicate a plurality of STA IDs for RDV1, a duration until a second rendezvous RDV2, and an RU identifier serving as a boundary to indicate a plurality of STA IDs for RDV2. Each STA is associated with a particular RU by virtue of its response to the trigger frame on that RU.

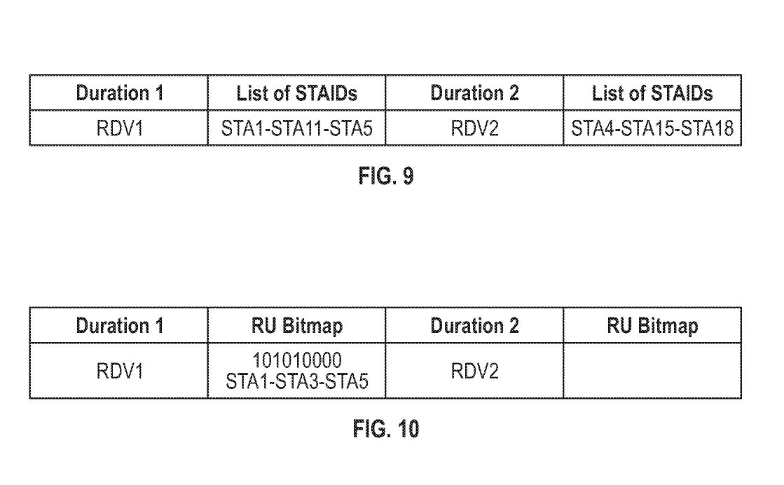

In another embodiment, as in the multicast design of HE variant of HT control field, the multi-STA RDV field may include one or more lists of STA IDs and duration until an RVT for each such list. FIG. 9 shows an example of this type of multi-STA RDV field with a duration 1 until a first rendezvous RDV1, a list of STA IDs for RDV1, a duration 2 until a second rendezvous RDV2, and a list of STA IDs for RDV2. In another embodiment, as in the embodiment shown in FIG. 8, a compression mechanism using the RU assignments of the different STAs in the previous UL transmission that elicited the M-BA is employed. As shown in FIG. 10, the multi-STA RDV field includes a list of RVTs, each with a list of RUs or an RU bitmap indicating the RUs where the STA AID can be derived from the RU. Alternatively, a simple RU boundary may indicate intervals of RUs with the previous boundary where all STAs in this interval would be associated with that RVT.

In another embodiment, the RVT information is included in an M-BA transmitted in response to UL transmissions from STAs on specific MU-MIMO resources assigned to the STAs in a trigger frame sent by the AP. In this situation, multiple STAs may be allocated on the same RU but with different spatial streams. In one example, the compression mechanism in this case can be the same as described above using only the RU allocations so that a single RU maps to multiple STAs. In another example, the bitmap is extended to include the number of STAs in the same RU using the order from lower spatial streams to higher spatial streams. In another example, the boundary for indicating multiple STAs is a combination of an RU and an index of the SS assignment to STAs per RU.

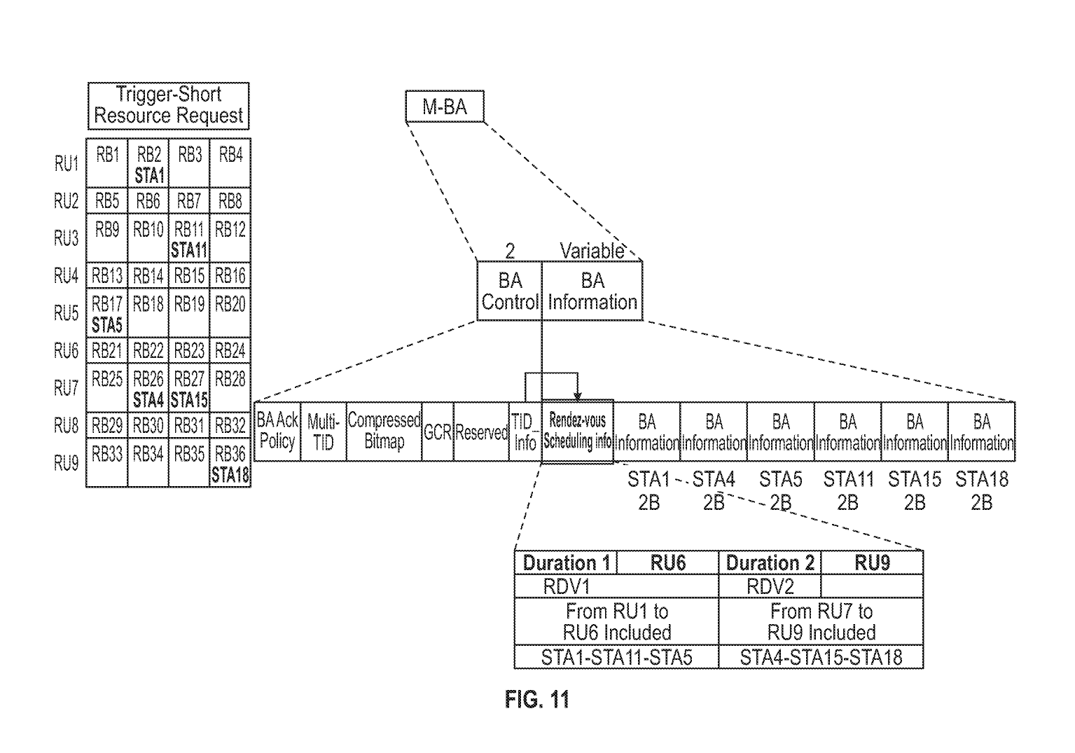

In another embodiment, the RVT information is included in an M-BA transmitted in response to short feedback UL transmissions from STAs where STAs are allocated resource blocks (RBs) instead of RUs. In one example as illustrated in FIG. 11, the compression mechanism may be the same as discussed above so that so that a single RU in the rendezvous scheduling information field indicates multiple STAs even though the STAs are assigned different RBs. In another example, the compression mechanism uses the RB allocations so that an RB maps only one STA. This may be implemented with a bitmap or boundary indication as discussed above where an RB bitmap is used instead of RU bitmap or an RB boundary indication is used instead of an RU boundary indication.

### Example UE Description

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

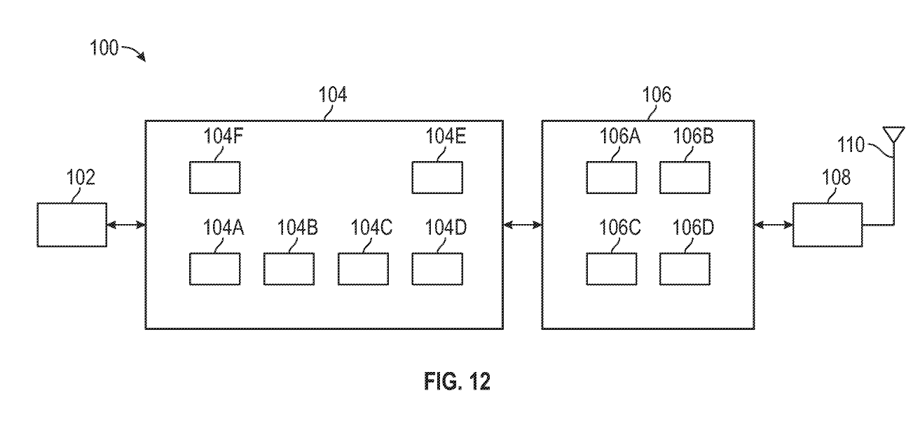

Embodiments described herein may be implemented into a system using any suitably configured hardware and/or software. FIG. 12 illustrates, for one embodiment, example components of a User Equipment (UE) device 100. In some embodiments, the UE device 100 may include application circuitry 102, baseband circuitry 104, Radio Frequency (RF) circuitry 106, front-end module (FEM) circuitry 108 and one or more antennas 110, coupled together at least as shown.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuitry 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (FFT), precoding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some dual-mode embodiments, a separate radio IC circuitry may be provided for processing signals for each spectrum, although the scope of the embodiments is not limited in this respect.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to is help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110.

In some embodiments, the UE device 100 may include additional elements such as, for example, memory/storage, display, camera, sensor, and/or input/output (I/O) interface.

### Example Machine Description

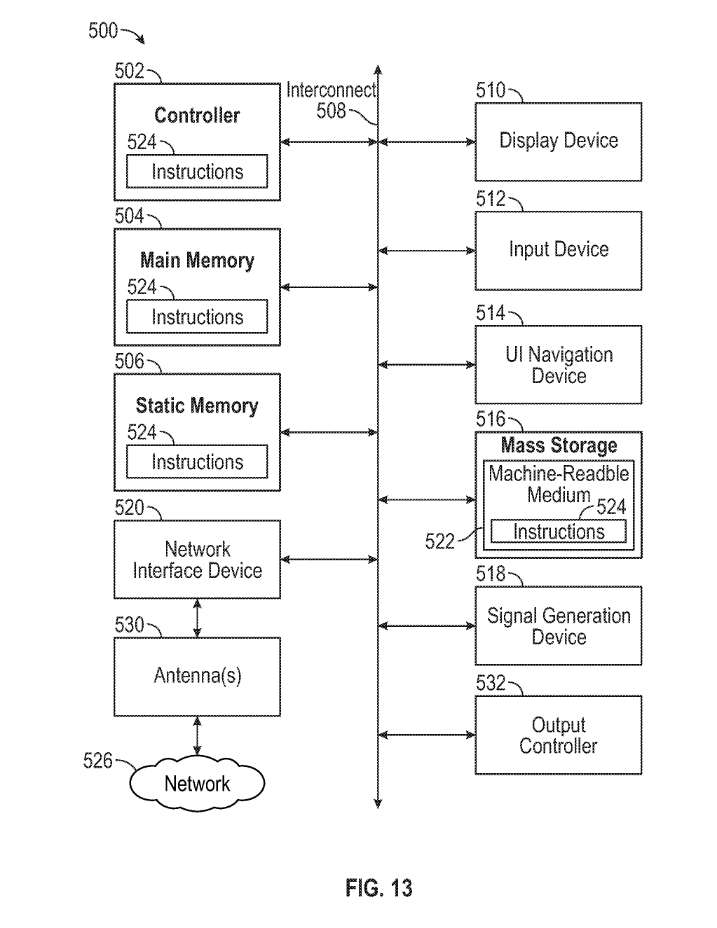

FIG. 13 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a user equipment (UE), evolved Node B (eNB), Wi-Fi access point (AP), Wi-Fi station (STA), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may he configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES AND EXAMPLES

In Example 1, an apparatus for a wireless access point (AP) comprises: memory and processing circuitry; wherein the processing circuitry is to: schedule download (DL) and/or upload (UL) traffic for a first set of one or more STAs during a first transmit opportunity (TxOP); before or during the first TxOP, determine a rendezvous time (RVT) at which the AP will access or attempt to access a wireless medium to schedule traffic for a second set of one or more STAs during a second TxOP subsequent to the first TxOP; and, encode RVT information in a medium access control (MAC) frame for transmission to the second set of STAs during the first TxOP.

In Example 2, the subject matter of any of the Examples herein may optionally include wherein the RVT information includes a duration between the time the RVT information is transmitted and when the RVT will occur.

In Example 3, the subject matter of any of the Examples herein may optionally include wherein the RVT information includes an association ID (AID) of one or more STAs that are to be scheduled at the RVT.

In Example 4, the subject matter of any of the Examples herein may optionally include wherein the RVT information includes whether a downlink (DL) or uplink (UL) transmission is to be scheduled at the RVT.

In Example 5, the subject matter of any of the Examples herein may optionally include wherein the processing circuitry is to encode the RVT information in a downlink rendezvous frame.

In Example 6, the subject matter of any of the Examples herein may optionally include wherein the processing circuitry is to encode the RVT information in a control information subfield of a HE (high-efficiency) variant of an HT (high-throughput) control field.

In Example 7, the subject matter of any of the Examples herein may optionally include wherein the processing circuitry is to encode the RVT information in separate per user subfields of the MAC frame to inform multiple STAs of an RVT for each STA.

In Example 8, the subject matter of any of the Examples herein may optionally include wherein the processing circuitry is to encode the RVT information in a common subfield of the MAC frame to inform multiple STAs of an RVT for each STA.

In Example 9, the subject matter of any of the Examples herein may optionally include wherein the processing circuitry is to encode the RVT information in a multi-STA block acknowledgement (M-BA) frame.

In Example 10, the subject matter of any of the Examples herein may optionally include wherein the processing circuitry is to encode the M-BA frame in response to UL transmissions from STAs on specific resources assigned to the STAs in a trigger frame sent by the AP.

In Example 11, the subject matter of any of the Examples herein may optionally include wherein the specific resources assigned to the STAs in the trigger frame are subsets of orthogonal frequency division multiple access (OFDMA) subcarriers, referred to as resource units (RUs).

In Example 12, the subject matter of any of the Examples herein may optionally include wherein the specific resources assigned to the STAs in the trigger frame are multi-user multiple-input-multiple-output (MU-MIMO) spatial streams.

In Example 13, the subject matter of any of the Examples herein may optionally include wherein the specific resources assigned to the STAs in the trigger frame are resource blocks (RBs) where a particular RB corresponds to a particular subset of orthogonal frequency division multiple access (OFDMA) subcarriers, referred to as a resource unit (RU) and a particular multi-user multiple-input-multiple-output (MU-MIMO) spatial stream.

In Example 14, the subject matter of any of the Examples herein may optionally include wherein the UL transmission of a STA in response to the trigger frame comprises energy in a high-efficiency long training field (HE-LTF) on the STA's assigned RB.

In Example 15, the subject matter of any of the Examples herein may optionally include wherein the processing circuitry is to encode the M-BA in response to bandwidth requests from the STAs.

In Example 16, the subject matter of any of the Examples herein may optionally include wherein the processing circuitry is to encode the M-BA in response to power saving poll (PS-poll) frames from the STAs.

In Example 17, an apparatus for a wireless station (STA) comprises: memory and processing circuitry, wherein the processing circuitry is to: during a first transmit opportunity (TxOP) of an access point (AP), demodulate rendezvous time (RVT) information sent in a medium access control (MAC) frame from the AP; wherein the RVT is a time at which the AP will access or attempt to access a wireless medium to schedule traffic for the STA during a second TxOP subsequent to the first TxOP; and, make a decision whether to enter a sleep state or remain in an awake state based upon the RVT information.

In Example 18, the subject matter of any of the Examples herein may optionally include wherein the RVT information includes a duration between the time the RVT information is transmitted and when the RVT will occur.

In Example 19, the subject matter of any of the Examples herein may optionally include wherein the RVT information includes an association ID (AID) of one or more STAs that are to be scheduled at the RVT.

In Example 20, the subject matter of any of the Examples herein may optionally include wherein the RVT information includes whether a downlink (DL) or uplink (UL) transmission is to be scheduled at the RVT.

In Example 21, the subject matter of any of the Examples herein may optionally include wherein the processing circuitry is to demodulate the RVT information in a downlink rendezvous frame.

In Example 22, the subject matter of any of the Examples herein may optionally include wherein the processing circuitry is to demodulate the RVT information in a control information subfield of a HE (high-efficiency) variant of an HT (high-throughput) control field.

In Example 23, the subject matter of any of the Examples herein may optionally include wherein the processing circuitry is to demodulate the RVT information in separate per user subfields of the MAC frame to inform multiple STAs of an RVT for each STA.

In Example 24, the subject matter of any of the Examples herein may optionally include wherein the processing circuitry is to demodulate the RVT information in a common subfield of the MAC frame to inform multiple STAs of an RVT for each STA.

In Example 25, the subject matter of any of the Examples herein may optionally include wherein the processing circuitry is to demodulate the RVT information in a multi-STA block acknowledgement (M-BA) frame.

In Example 26, the subject matter of any of the Examples herein may optionally include wherein the processing circuitry is to demodulate the M-BA frame in response to a UL transmission from the STA on specific resources assigned to the STA in a trigger frame sent by the AP, wherein the specific resources assigned to the STA in the trigger frame are subsets of orthogonal frequency division multiple access (OFDMA) subcarriers, referred to as resource units (RUs), wherein the specific resources assigned to the STA in the trigger frame are multi-user multiple-input-multiple-output (MU-MIMO) spatial streams, or wherein the specific resources assigned to the STA in the trigger frame is a resource block (RB) where a particular RB corresponds to a particular subset of orthogonal frequency division multiple access (OFDMA) subcarriers, referred to as a resource unit (RU) and a particular multi-user multiple-input-multiple-output (MU-MIMO) spatial stream.

In Example 27, the subject matter of any of the Examples herein may optionally include wherein the STA is to encode its UL transmission in response to the trigger frame as energy in a high-efficiency long training field (HE-LTF) on the STA's assigned RB.

In Example 28, the subject matter of any of the Examples herein may optionally include wherein the processing circuitry is to demodulate the M-BA in response to a bandwidth requests from the STA.

In Example 29, the subject matter of any of the Examples herein may optionally include wherein the processing circuitry is to demodulate the M-BA in response to a power saving poll (PS-poll) frame from the STA.

In Example 30, the subject matter of any of the Examples herein may optionally include a radio transceiver having one or more antennas connected to the processing circuitry.

In Example 31, a computer-readable medium contains instructions to cause a wireless station (STA) or access point (AP), upon execution of the instructions by processing circuitry of the STA or AP, to perform any of the functions of the processing circuitry as recited by any of the Examples herein.

In Example 32, a method for operating a wireless station or access point comprises performing any of the functions of the processing circuitry and/or radio transceiver as recited by any of the Examples herein.

In Example 33, an apparatus for a wireless station or access point comprises means for performing any of the functions of the processing circuitry and/or radio transceiver as recited by any of the Examples herein.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect. An example LTE system includes a number of mobile stations, defined by the LTE specification as User Equipment (UE), communicating with a base station, defined by the LTE specifications as an eNodeB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11-2007 and/or 802.11(n) standards and/or proposed specifications for WLANs, although the scope of the disclosure is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the disclosure is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An apparatus for a wireless access point (AP), the apparatus comprising:
memory and processing circuitry, wherein the processing circuitry is to:
schedule download (DL) and/or upload (UL) traffic for a first set of one or more during a first transmit opportunity (TxOP);
before or during the first TxOP, determine a rendezvous time (RVT) at which the AP will access or attempt to access a wireless medium to schedule traffic for a second set of one or more STAs during a second TxOP subsequent to the first TxOP; and,
encode RVT information in a medium access control (MAC) frame for transmission to the second set of STAs during the first TxOP.

2. The apparatus of claim 1 wherein the RVT information includes a duration between the time the RVT information is transmitted and when the RVT will occur.

3. The apparatus of claim 1 wherein the processing circuitry is to encode the RVT information in a control information subfield of a HE (high-efficiency) variant of an HT (high-throughput) control field.

4. The apparatus of claim 1 wherein the processing circuitry is to encode the RVT information in separate per user subfields of the MAC frame to inform multiple STAs of an RVT for each STA.

5. The apparatus of claim 1 wherein the processing circuitry is to encode the RVT information in a common subfield of the MAC frame to inform multiple STAs of an RVT for each STA.

6. The apparatus of claim 1 wherein the processing circuitry is to encode the RVT information in a multi-STA block acknowledgement (M-BA) frame.

7. The apparatus of claim 6 wherein the processing circuitry is to encode the M-BA frame in response to UL transmissions from STAs on specific resources assigned to the STAs in a trigger frame sent by the AP.

8. The apparatus of claim 6 wherein the specific resources assigned to the STAs in the trigger frame are subsets of orthogonal frequency division multiple access (OFDMA) subcarriers, referred to as resource units (RUs).

9. The apparatus of claim 6 wherein the specific resources assigned to the STAs in the trigger frame are multi-user multiple-input-multiple-output (MU-MIMO) spatial streams.

10. The apparatus of claim 6 wherein the specific resources assigned to the STAs in the trigger frame are resource blocks (RBs) where a particular RB corresponds to a particular subset of orthogonal frequency division multiple access (OFDMA) subcarriers, referred to as a resource unit (RU) and a particular multi-user multiple-input-multiple-output (MU-MIMO) spatial stream.

11. The apparatus of claim 10 wherein the UL transmission of a STA in response to the trigger frame comprises energy in a high-efficiency long training field (HE-LTF) on the STA's assigned RB.

12. The apparatus of claim 10 wherein the processing circuitry is to encode the M-BA in response to bandwidth requests from the STAs.

13. The apparatus of claim 10 wherein the processing circuitry is to encode the M-BA in response to power saving poll (PS-poll) frames from the STAs.

14. An apparatus for a wireless station (STA), the apparatus comprising:
memory and processing circuitry, wherein the processing circuitry is to:
during a first transmit opportunity (TxOP) of an access point (AP), demodulate rendezvous time (RVT) information sent in a medium access control (MAC) frame from the AP;
wherein the RVT is a time at which the AP will access or attempt to access a wireless medium to schedule traffic for the STA during a second TxOP subsequent to the first TxOP; and,
make a decision whether to enter a sleep state or remain in an awake state based upon the RVT information, wherein the RVT information includes a duration between the time the RVT information is transmitted and when the RVT will occur.

15. The apparatus of claim 14 wherein the processing circuitry is to demodulate the M-BA in response to a bandwidth request from the STA.

16. The apparatus of claim 14 wherein the processing circuitry is to demodulate the M-BA in response to a power saving poll (PS-poll) frame from the STA.

17. A method for operating a wireless access point (AP), comprising:
scheduling download (DL) and/or upload (UL) traffic for a first set of one or more STAs in the network during a first transmit opportunity (TxOP);
before or during the first TxOP, determining a rendezvous time (RVT) at which the device will access or attempt to access the network to schedule traffic for a second set of one or more STAs during a subsequent second TxOP; and,
encoding RVT information in a medium access control (MAC) frame for transmission to the second set of STAs during the first TxOP.

18. The method of claim 17 further comprising including in the RVT information a duration between the time the RVT information is transmitted and when the RVT will occur.

19. The method of claim 17 further comprising encoding the RVT information in a control information subfield of a HE (high-efficiency) variant of an HT (high-throughput) control field.

20. The method of claim 17 further comprising encoding the RVT information in a multi-STA block acknowledgement (M-BA) frame and encoding the M-BA frame in response to UL transmissions from STAs on specific resources assigned to the STAs in a trigger frame sent by the AP.

21. A computer-readable medium comprising instructions to cause a wireless access point (AP), upon execution of the instructions by processing circuitry of the AP, to:
schedule download (DL) and/or upload (UL) traffic for a first set of one or more STAs in the network during a first transmit opportunity (TxOP);
before or during the first TxOP, determine a rendezvous time (RVT) at which the device will access or attempt to access the network to schedule traffic for a second set of one or more STAs during a subsequent second TxOP; and,
encode RVT information in a medium access control (MAC) frame for transmission to the second set of STAs during the first TxOP, wherein the RVT information includes a duration between the time the RVT information is transmitted and when the RVT will occur.

22. The medium of claim 21 further comprising instructions to encode the RVT information in a DL rendezvous frame.

23. The medium of claim 21 further comprising instructions to encode the RVT information in separate per user subfields of the MAC frame to inform multiple STAs of an RVT for each STA.

24. The medium of claim 21 further comprising instructions to encode the RVT information in a common subfield of the MAC frame to inform multiple STAs of an RVT for each STA.

25. The medium of claim 21 further comprising instructions to encode the RVT information in a multi-STA block acknowledgement (M-BA) frame.
